(19) United States
(12) Patent Application Publication
(10) Pub. No.: US 2010/0172665 A1
(43) Pub. Date: Jul. 8, 2010

(54) IMAGE FORMING APPARATUS AND IMAGE FORMING METHOD

(75) Inventor: Yujiro Nomura, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/683,372

(22) Filed: Jan. 6, 2010

(30) Foreign Application Priority Data
Jan. 8, 2009 (JP) 2009-002436

(51) Int. Cl. G03G 15/043

(52) U.S. Cl. 399/51

(57) ABSTRACT

An image forming apparatus comprising: a latent image carrying member that carries a latent image; a drive unit that drives to rotate the latent image carrying member; an exposure head that includes a first imaging optical system, a first light-emitting element that emits light imaged on the latent image carrying member by the first imaging optical system, a second imaging optical system that is disposed at a different position from that of the first imaging optical system in a rotation direction of the latent image carrying member, and a second light-emitting element that emits light imaged on the latent image carrying member by the second imaging optical system; a storage unit that stores light-emitting timing adjustment information used for adjusting a timing at which the second light-emitting element emits light; and a control unit that determines a first light-emitting timing at which the first light-emitting element emits light and a second light-emitting timing on the basis of the light-emitting timing adjustment information, and allows the second light-emitting element to emit light at the second light-emitting timing.

### BACKGROUND

1. Technical Field

The present invention relates to a technique for exposing a latent image carrying member with light emitted from a light-emitting element.

2. Related Art

In general, there is known an image forming apparatus which allows a light-emitting element to emit light while rotating a photoconductive drum in a sub-scanning direction and exposes a surface of the photoconductive drum. In JP-A-2008-036937, there is disclosed a line head for performing such an exposing operation. In the line head, a lens array having a plurality of lens which is arranged in a zigzag pattern in a main scanning direction (a direction perpendicular to the sub-scanning direction) is provided. In addition, a light-emitting element is provided for each lens, and light emitted from the light-emitting element is imaged by the lens. Then a surface of a photoconductive drum is exposed with the imaged light, thereby forming a latent image on the surface of the photoconductive drum.

As described above, in the line head, the plurality of lenses are arranged in the zigzag pattern. Therefore, two or more lenses are disposed at positions where the sub-scanning directions are different. The lenses disposed at difference positions in the sub-scanning direction expose positions where the sub-scanning directions are different. Accordingly, as illustrated in FIG. 11 of JP-A-2008-036937, in the line head, the lenses disposed at different positions in the sub-scanning direction form latent images at different timings. The latent images formed by the lenses are connected to form a latent image corresponding to one line in the main scanning direction.

More specifically, this will be described using a first lens and a second lens disposed on a downstream side in the sub-scanning direction from the first lens. First, the first lens forms a latent image on a surface of a photoconductive drum at a certain timing. The latent image is moved toward the downstream side in the sub-scanning direction as the surface of the photoconductive drum moves. At a timing after a predetermined time after the first lens forms the latent image, the second lens forms a latent image. The latent images formed by the first and second lenses at different timings are connected in the main scanning direction, thereby forming a line-shaped latent image. Therefore, in order to properly form the latent image using such a line head, it is important for the first and second lenses to form the latent images at appropriate timings according to the movement of the surface of the photoconductive drum.

However, there may be a case where a speed (circumferential speed) of a surface of a latent image carrying member such as the photoconductive drum may fluctuate as the latent image carrying member becomes eccentric. That is, when the latent image carrying member is eccentric, a distance from the rotation center to the surface of the latent image carrying member varies depending on the position on the surface of the latent image carrying member. As a result, on the surface of the latent image carrying member, in some cases, at a position where the distance from the rotation center is great, the circumferential speed increases, and at a position where the distance from the rotation center is small, the circumferential speed decreases. Furthermore, when the circumferential speed of the latent image carrying member fluctuates due to the eccentricity of the latent image carrying member, there is a concern that the latent images formed by the corresponding imaging optical systems (the first and second lenses) are misaligned from each other (in other words, the latent images formed by the imaging optical systems are not properly connected in the main scanning direction), and an appropriate latent image forming operation cannot be performed.

### SUMMARY

An advantage of some aspects of the invention is that it provides a technique for suppressing misalignment between latent images formed by imaging optical systems, which is caused by eccentricity of a latent image carrying member, thereby realizing a proper latent image forming operation.

According to an aspect of the invention, there is provided an image forming apparatus including: a latent image carrying member that carries a latent image; a drive unit that drives to rotate the latent image carrying member; an exposure head that includes a first imaging optical system, a first light-emitting element that emits light imaged on the latent image carrying member by the first imaging optical system, a second imaging optical system that is disposed at a different position from that of the first imaging optical system in a rotation direction of the latent image carrying member, and a second light-emitting element that emits light imaged on the latent image carrying member by the second imaging optical system; a storage unit that stores light-emitting timing adjustment information used for adjusting a timing at which the second light-emitting element emits light; and a control unit that determines a first light-emitting timing at which the first light-emitting element emits light and a second light-emitting timing on the basis of the light-emitting timing adjustment information, and allows the second light-emitting element to emit light at the second light-emitting timing.

According to another aspect of the invention, there is provided an image forming method including: determining a second light-emitting timing at which a second light-emitting element emits light, the second light-emitting element being included in an exposure head that includes a first imaging optical system, a first light-emitting element that emits light imaged on a latent image carrying member by the first imaging optical system, a second imaging optical system disposed at a different position from that of the first imaging optical system in a rotation direction of the latent image carrying member, and the second light-emitting element that emits light imaged on the latent image carrying member by the second imaging optical system; and allowing the second light-emitting element to emit light at the second light-emitting timing determined in the determining, wherein in the determining, light-emitting timing adjustment information used for adjusting the timing at which the second light-emitting element emits light is read from a storage unit, and the second light-emitting timing is determined on the basis of the first light-emitting timing at which the first light-emitting element emits light and the light-emitting timing adjustment information to allow the second light-emitting element to emit light at the second light-emitting timing.

According to the aspect of the invention (the image forming apparatus and the image forming method), the first and second imaging optical systems are disposed at different positions in the rotation direction of the latent image carrying member. In addition, the first light-emitting element corresponding to the first imaging optical system emits light to expose the latent image carrying member, and the second light-emitting element corresponding to the second imaging optical system emits light to expose the latent image carrying member. Here, in such a configuration described above, there is a concern that a latent image formed by the first imaging optical system and a latent image formed by the second imaging optical system are misaligned with each other. On the contrary, according to the aspects of the invention, the light-emitting timing adjustment information used for adjusting the timing at which the second light-emitting element emits light is stored in the storage unit. Furthermore, the second light-emitting timing is determined on the basis of the first light-emitting timing at which the first light-emitting element emits light and the light-emitting timing adjustment information, so that the second light-emitting element is allowed to emit light at the second light-emitting timing. Therefore, it is possible to suppress the misalignment of the latent images.

However, besides the above-mentioned reason, for the following reason, there may be a case where the latent image formed by the first imaging optical system and the latent image formed by the second imaging optical system are misaligned. That is, a driving speed of the drive unit that drives the latent image carrying member may fluctuate. If the fluctuation in the driving speed occurs, a speed of the latent image carrying member also fluctuates. For this reason, there may be a case where the misalignment of the latent images occurs.

Therefore, a rotation angle detection unit for detecting a rotation angle of the latent image carrying member may be included, and the control unit may be configured to adjust the light-emitting timing of the second light-emitting element on the basis of a detection result of the rotation angle detection unit. Accordingly, the misalignment of the latent images caused by the driving speed fluctuation can be suppressed, so that it is possible to perform an exposing operation more properly.

In addition, it is suitable to apply the aspects of the invention to the image forming apparatus in which the latent image carrying member has a rotation shaft and the drive unit drives to rotate the rotation shaft. This is because in this image forming apparatus, the driving speed of the drive unit is not uniform, an angular speed of the latent image carrying member fluctuates, and the latent image carrying member becomes eccentric, so that there is a concern that a fluctuation in circumferential speed of the latent image carrying member is likely to occur.

The rotation angle detection unit is an encoder mounted to the rotation shaft of the latent image carrying member. As the encoder is mounted to the rotation shaft of the latent image carrying member, it is possible to detect the rotation angle of the latent image carrying member by the encoder.

However, the latent image carrying member may be configured to be held by a cartridge that is able to be attached to or detached from a main body of the image forming apparatus. With such a configuration, the cartridge is replaced as necessary for the repair of the image forming apparatus. In addition, in a case where the latent image carrying member is replaced with a new one due to the replacement of the cartridge, it is necessary to use the light-emitting timing adjustment information considering the eccentricity of the new latent image carrying member. Therefore, the storage unit that stores the light-emitting timing adjustment information may be mounted in the cartridge. With such a configuration, if the light-emitting timing adjustment information according to the eccentricity of the latent image carrying member is stored in the storage unit when a factory default of the cartridge is set, with a change in the latent image carrying member due to the replacement of the cartridge, the light-emitting timing adjustment information can be suitably modified according to the change in the latent image carrying member. That is, without performing a specific operation other than the cartridge replacement, suitable light-emitting timing adjustment information can be prepared. Therefore, this configuration is preferable.

In addition, in the configuration in which the storage unit is mounted in the cartridge, it is suitable that the storage unit is a non-volatile memory.

### BRIEF DESCRIPTION OF THE DRAWINGS

The invention will be described with reference to the accompanying drawings, wherein like numbers reference like elements.

FIG. 1 is a view illustrating an example of an image forming apparatus which can apply the invention.

FIG. 2 is a view illustrating an electrical configuration of the image forming apparatus of FIG. 1.

FIG. 3 is a perspective view schematically illustrating a line head.

FIG. 4 is a plan view illustrating a configuration of a rear surface of a head substrate.

FIG. 5 is a timing chart showing a timing at which a horizontal request signal is output.

FIG. 6 is a plan view illustrating an exposing operation at time t(1).

FIG. 7 is a plan view illustrating an exposing operation at time t(2).

FIG. 8 is a plan view illustrating an exposing operation at time t(1+160)=t(161).

FIG. 9 is a plan view illustrating an exposing operation at time t(1+160×2)=t(321).

FIG. 10 is a view illustrating effects of eccentricity of a photoconductive drum on a circumferential speed of the photoconductive drum.

FIG. 11 is a perspective view illustrating a configuration for detecting a rotation angle of the photoconductive drum.

FIG. 12 is a side view illustrating the configuration for detecting the rotation angle of the photoconductive drum.

FIG. 13 is a timing chart showing a method of correcting the horizontal request signal on the basis of a fluctuation in driving speed.

### DESCRIPTION OF EXEMPLARY EMBODIMENTS

### A. Basic Configuration

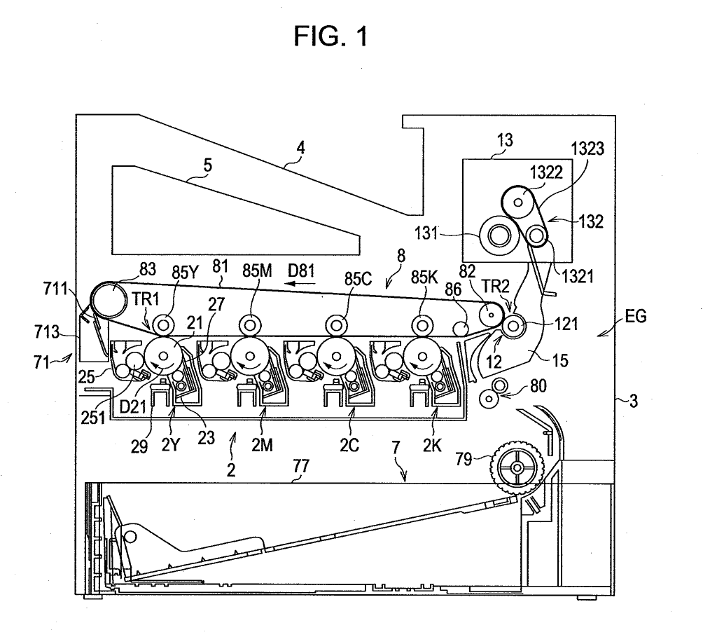

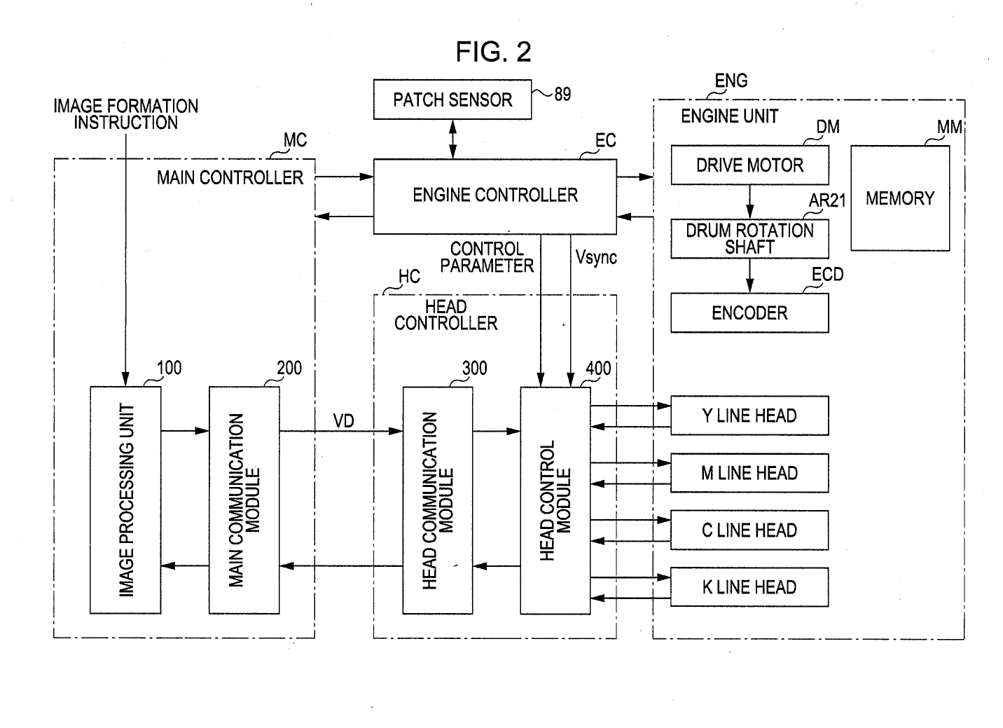

FIG. 1 is a view illustrating an example of an image forming apparatus which can apply the present invention. FIG. 2 is a view illustrating an electrical configuration of the image forming apparatus illustrated in FIG. 1. This apparatus is an image forming apparatus which selectively performs a color mode of forming a color image by overlapping toners of four colors: yellow (Y), magenta (M), cyan (C), and black (K), and a monochrome mode of forming a monochrome image using only black (K) toner. In the image forming apparatus, when an image formation instruction is given to a main controller MC having a CPU, a memory, and the like from an external apparatus such as a host computer, the main controller MC gives a control signal to an engine controller EC, and then the engine controller EC controls each unit in the apparatus such as an engine unit ENG and a head controller HC on the basis of the control signal to perform a predetermined image forming operation, thereby forming an image corresponding to the image formation instruction on a sheet which is a recording medium such as a copying paper, a transfer paper, a paper, and an OHP transparent sheet.

In a housing main body 3 of the image forming apparatus, there is provided an electrical component box 5 in which a power circuit board, the main controller MC, the engine controller EC, and the head controller HC are installed. In addition, an image forming unit 2, a transfer belt unit 8, and a feed unit 7 are arranged in the housing main body 3. In FIG. 1, on the right in the housing main body 3, a secondary transfer unit 12, a fixing unit 13, and a sheet guide member 15 are arranged. The feed unit 7 is able to be attached to and detached from the housing main body 3. Furthermore, the feed unit 7 and the transfer belt unit 8 are configured so that they can be separated from the housing main body 3 to be repaired or replaced.

The image forming unit 2 includes four image forming stations 2Y (yellow), 2M (magenta), 2C (cyan), and 2K (black) for forming an image with a plurality of different colors. In FIG. 1, since the image forming stations of the image forming unit 2 have the same configuration, for the convenience of illustration, only one of the image forming stations is denoted by reference numerals, and reference numerals for other image forming stations will be omitted.

Each of the image forming stations 2Y, 2M, 2C, and 2K is provided with a photoconductive drum 21 wherein a toner image with corresponding color is formed on its surface. A rotation shaft AR21 of each photoconductive drum 21 is disposed to be parallel or substantially parallel to a main scanning direction MD (a direction perpendicular to the plane of FIG. 1). In addition, the rotation shaft AR21 of each photoconductive drum 21 is connected to its dedicated drive motor DM to rotate in a direction of an arrow D21 in the figure at a predetermined speed. Accordingly, the surface of the photoconductive drum 21 is transported in a sub-scanning direction SD that is perpendicular or substantially perpendicular to the main scanning direction MD. In the vicinity of the photoconductive drum 21, a charger 23, a line head 29, a developing unit 25, a photoconductive cleaner 27 are arranged along the rotation direction. In addition, a charging operation, a latent image forming operation, and a toner developing operation are executed by function units thereof. In the color mode, toner images formed by all the image forming stations 2Y, 2M, 2C, and 2K are overlapped onto a transfer belt 81 provided in the transfer belt unit 8 to form a color image. In the monochrome mode, only the image forming station 2K is operated to form a black or monochromatic image.

The charger 23 has a charge roller with a surface made of an elastic rubber. The charge roller is configured to be driven by contacting the surface of the photoconductive drum 21 at a charge position and is rotated as the photoconductive drum 21 rotates. Furthermore, the charge roller is connected to a charge bias generator (not shown) and is supplied with a charge bias from the charge bias generator to charge the surface of the photoconductive drum 21 at a predetermined surface potential at a charge position where the charger 23 and the photoconductive drum 21 abut on each other.

The line head 29 is disposed so that the longitudinal direction LGD thereof is parallel or substantially parallel to the main scanning direction MD, and the lateral direction LTD thereof is parallel or substantially parallel to the sub-scanning direction SD. The line head 29 includes a plurality of light-emitting elements and opposes the photoconductive drum 21. In addition, the line head 29 forms an electrostatic latent image on the surface of the photoconductive drum 21 charged by the charger 23 by imaging light emitted from the light-emitting element.

The developing unit 25 includes a developing roller 251 wherein toner is carried on its surface. In addition, by a developing bias applied to the developing roller 251 from a developing bias generator (not shown) which is electrically connected to the developing roller 251, at a development position where the developing roller 251 and the photoconductive drum 21 abut on each other, charged toner is moved from the developing roller 251 to the photoconductive drum 21, thereby developing the electrostatic latent image formed on the surface of the photoconductive drum 21.

The toner image developed at the development position is transported in the rotation direction D21 of the photoconductive drum 21 and is primarily transferred onto the transfer belt 81 at a primary transfer position TR1 where the transfer belt 81 and each photoconductive drum 21 abut on each other.

The photoconductive cleaner 27 is provided on a downstream side of the primary transfer position TR1 of the rotation direction D21 of the photoconductive drum 21 and an upstream side of the charger 23 so that the photoconductive cleaner 27 abuts on the surface of the photoconductive drum 21. The photoconductive cleaner 27 removes the residual toner on the surface of the photoconductive drum 21 after the primary transfer as it comes in contact with the surface of the photoconductive drum 21.

The transfer belt unit 8 includes a driving roller 82, a driven roller 83 (blade opposed roller) on the left side from the driving roller 82 in FIG. 1, and the transfer belt 81 stretched across the rollers to circularly drive in a direction (transport direction) of an arrow D81 illustrated as the driving roller 82 rotates. In addition, the transfer belt unit 8 includes four primary transfer rollers 85Y, 85M, 85C, and 85K which are opposed to the photoconductive drums 21 of the respective image forming stations 2Y, 2M, 2C and 2K one to one when a cartridge is mounted inside the transfer belt 81. The primary transfer rollers are electrically connected to their respective primary transfer bias generators (not shown).

In the color mode, as illustrated in FIG. 1, by positioning all the first primary transfer rollers 85Y, 85M, 85C, and 85K on the sides of the image forming stations 2Y, 2M, 2C, and 2K, the transfer belt 81 is thrust to abut on the photoconductive drums 21 of the respective image forming stations 2Y, 2M, 2C, and 2K, thereby forming the primary transfer position TR1 between each photoconductive drum 21 and the transfer belt 81. Then, at an appropriate timing, a primary transfer bias is applied to the primary transfer roller 85Y or the like from the primary transfer bias generator, to transfer the toner image formed on the surface of each photoconductive drum 21 onto the surface of the transfer belt 81 at the corresponding primary transfer position TR1. That is, in the color mode, the monochrome color toner images are overlapped on the transfer belt 81 to form a color image.

Furthermore, the transfer belt unit 8 includes a downstream guide roller 86 disposed on the downstream side of the primary transfer roller 85K for black color and on the upstream side of the driving roller 82. The downstream guide roller 86 is configured to abut on the transfer belt 81 on a common tangent line of the primary transfer roller 85K and the photoconductive drum 21(K) for black color at the primary transfer position TR1 where the primary transfer roller 85K abuts on the photoconductive drum 21 of the image forming station 2K.

A patch sensor 89 is provided to oppose the surface of the transfer belt 81 running over the downstream guide roller 86. The patch sensor 89 is configured by, for example, a reflection-type photosensor, and detects a position of a patch image formed on the transfer belt 81 or a density thereof as necessary by optically detecting a change in reflectance of the surface of the transfer belt 81.

The feed unit 7 includes a feed part having a feed cassette 77 in which sheets can be stacked and retained and a pick-up roller 79 which feeds the sheets from the feed cassette 77 one by one. The sheet fed by the feed part from the pick-up roller 79 has a feeding timing adjusted by a pair of resist rollers 80 and is then fed along the sheet guide member 15 to a secondary transfer position TR2 where the driving roller 82 and the secondary transfer roller 121 abut on each other.

The secondary transfer roller 121 is able to be brought into contact with or separated from the transfer belt 81 and is driven to be brought into contact or separated by a secondary transfer roller drive mechanism (not shown). The fixing unit 13 includes a heating roller 131 which includes a heating element such as a halogen heater therein and is rotatable and a pressurizing part 132 which presses and biases the heating roller 131. In addition, the sheet having the image secondarily transferred on its surface is guided by the sheet guide member 15 to a nip part formed by the heating roller 131 and a pressurizing belt 1323 of the pressurizing part 132, and the image is thermally fixed at the nip part at a predetermined temperature. The pressurizing part 132 is constituted by two rollers 1321 and 1322 and the pressurizing belt 1323 stretched across them. In addition, in the surface of the pressurizing belt 1323, by pressing a belt stretched surface stretched across the two rollers 1321 and 1322 toward a circumferential surface of the heating roller 131, the nip part formed by the heating roller 131 and the pressurizing belt 1323 can be widened. The sheet that is subjected to the fixing process as described above is transported to a discharge tray 4 provided on an upper surface portion of the housing main body 3.

The driving roller 82 drives the transfer belt 81 to circularly rotate in the direction of the illustrated arrow D81 and functions as a back-up roller of the secondary transfer roller 121. A circumferential surface of the driving roller 82 is made of a rubber layer with a thickness of about 3 mm and a volume resistivity of 1000 kΩ·cm or less and is grounded via a shaft made of metal, thereby serving as a conductive path of a secondary transfer bias supplied from a secondary transfer bias generator (not shown) via the secondary transfer roller 121. As such, since the rubber layer having high friction and shock absorption is provided in the driving roller 82, it is possible to prevent image quality deterioration caused by an impact transmitted to the transfer belt 81 when the sheet enters the secondary transfer position TR2.

Furthermore, in this apparatus, a cleaner unit 71 is arranged to oppose the blade opposed roller 83. The cleaner unit 71 includes a cleaner blade 711 and a waste toner box 713. The cleaner blade 711 abuts on the blade opposed roller 83 at its front end portion via the transfer belt 81, thereby removing foreign matter such as the residual toner on the transfer belt 81 after the secondary transfer and paper powder. The foreign matter removed as described above is recovered into the waste toner box 713. The cleaner blade 711 and the waste toner box 713 are formed integrally with the blade opposed roller 83.

The photoconductive drum 21, the charger 23, the developing unit 25, and the photoconductive cleaner 27 of each of the image forming stations 2Y, 2M, 2C, and 2K are integrally unitized as a cartridge. The cartridge is able to be attached to and detached from the apparatus main body. Each cartridge is provided with a non-volatile memory for storing information on the cartridge. In addition, wireless communications are performed between the engine controller EC and each cartridge. Accordingly, the information on each cartridge is transmitted to the engine controller EC and the information in each memory is updated and stored. On the basis of the information, a use history of each cartridge and life of consumables are managed.

The main controller MC, the head controller HC, and the line heads 29 are configured into different blocks, and they are connected via serial communication lines. Data exchange operations between the blocks will be described with reference to FIG. 2. When an image formation instruction is given to the main controller MC from an external apparatus, the main controller MC transmits a control signal for operating the engine unit ENG to the engine controller EC. An image processing unit 100 provided in the main controller MC generates video data VD for each toner color by performing a predetermined signal processing on image data included in the image formation instruction.

The engine controller EC that receives the control signal starts initialization and warm-up operations for each component in the engine unit ENG. When the operations are complete and the engine unit ENG is in a state capable of executing an image forming operation, the engine controller EC outputs a synchronization signal Vsync for activating the image forming operation to the head controller HC which controls each line head 29.

The head controller HC is provided with a head control module 400 for controlling each line head and a head communication module 300 which performs data communication with the main controller MC. The main controller MC is also provided with a main communication module 200. The main communication module 200 outputs one line of the video data VD to the head communication module 300 for a request from the head communication module 300. The head communication module 300 transmits the video data VD to the head control module 400. The head control module 400 allows the light-emitting element of each line head 29 to emit light on the basis of the received video data VD. In addition, as described later, a light-emitting timing of the light-emitting element is controlled on the basis of a horizontal request signal H-req. That is, the horizontal request signal H-req is a signal for giving a light-emitting timing to the light-emitting element, and the light-emitting element emits light in synchronization with the horizontal request signal H-req.

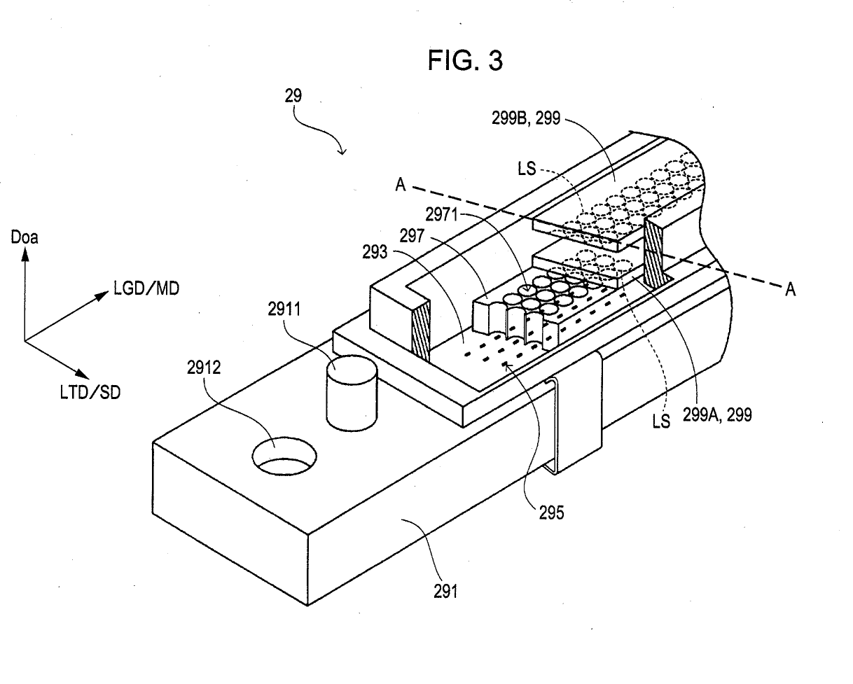

FIG. 3 is a perspective view schematically illustrating the line head. The line in the figure is a line parallel to a direction Da-a described later. As described above, the longitudinal direction LGD of the line head 29 is parallel or substantially parallel to the main scanning direction MD, and the lateral direction LTD of the line head 29 is parallel or substantially parallel to the sub-scanning direction SD. The longitudinal direction LGD and the lateral direction LTD of the line head 29 are perpendicular or substantially perpendicular to each other. Each light-emitting element of the line head 29 emits a light beam toward the surface of the photoconductive drum 21. Therefore, in the specification, as a direction perpendicular or substantially perpendicular to the longitudinal direction LGD and the lateral direction LTD, the direction from the light-emitting element toward the photoconductive drum surface is referred to a light beam travelling direction Doa. The light beam travelling direction Doa is parallel or substantially parallel to an optical axis OA of an imaging optical system described later.

A case 291 of the line head 29 is provided with positioning pins 2911 and screw insertion holes 2912 at both ends thereof in the longitudinal direction LGD. In addition, the positioning pin 2911 is fitted and inserted into a positioning hole (not shown) of a photoconductive cover (not shown) positioned with respect to the photoconductive drum 21 such that the line head 29 is positioned with respect to the photoconductive drum 21. In addition, a fixation screw inserted into the screw insertion hole 2912 is screwed into a threaded hole (not shown) of the photoconductive cover so as to fix the line head 29 to the photoconductive drum 21.

Inside the case 291, a head substrate 293, a light-shielding member 297, and two lens arrays 299 (299A and 299B) are disposed in this order in the light beam travelling direction Doa. Light-emitting element groups 295 are configured by grouping a plurality of light-emitting elements and are two-dimensionally and discretely arranged on a rear surface of the head substrate 293.

In each of the lens arrays 299A and 299B, a plurality of lenses LS oppose a plurality of the light-emitting element groups 295 in a one-to-one correspondence. As such, the plurality of lenses LS are two-dimensionally arranged in each lens array 299. The light-shielding member 297 interposed between the lens array 299 and the head substrate 293 is provided with light guide holes 2971 penetrating in the light beam travelling direction Doa. The light guide holes 2971 are provided for each light-emitting element group 295. Therefore, the light-emitting element group 295 emits a light beam toward the corresponding lens LS through the light guide hole 2971. Then the two lenses LS and LS image the light beam on the surface of the photoconductive drum 21 as a spot. As described above, since the light-shielding member 297 is provided, cross-talk in which the light emitted from the light-emitting element group 295 is incident onto the lens LS which does not correspond to the aforementioned light-emitting group 295 is suppressed.

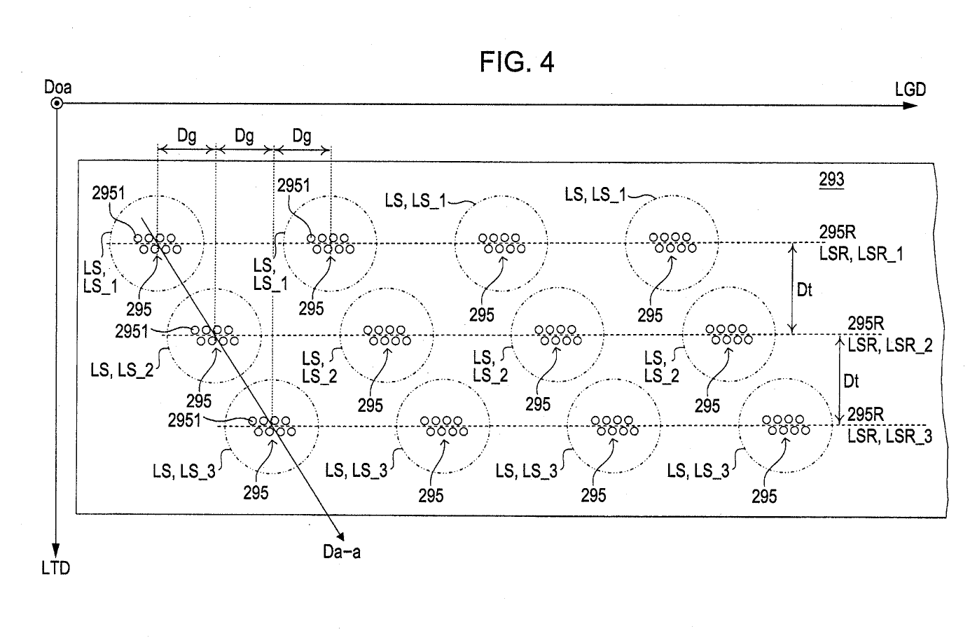

FIG. 4 is a plan view illustrating a configuration of the rear surface of the head substrate and corresponds to a case where the rear surface of the head substrate 293 is viewed from the front surface side. In FIG. 4, the lens LS is shown by a two-dot-dashed line to show a correspondence relationship between each lens LS of the lens arrays 299A and 299B and the light-emitting element group 295. Therefore, this does not mean that the lens LS is formed on the head substrate 293. The configuration and arrangement of the light-emitting element groups 295 will be described in detail with reference to FIG. 4.

As illustrated in FIG. 4, each light-emitting element group 295 is constituted by eight light-emitting elements 2951 which are arranged in two rows in a zigzag pattern in the longitudinal direction LGD. The plurality of light-emitting element groups 295 are arranged straightly at an interval which is three times an interval Dg in the longitudinal direction LGD thereby configuring a light-element group row 295R. In correspondence with this, in the lens array 299, the plurality of lenses LS is arranged straightly at an interval of Dg×3 in the longitudinal direction LGD thereby configuring a lens row LSR. In addition, the three light-emitting element group rows 295R are arranged at an interval Dt in the lateral direction LTD. In correspondence with this, with regard to the lens arrays 299, the three lens rows LSR are arranged at the interval Dt in the lateral direction LTD. Moreover, each light-emitting element group row 295R (each lens row LSR) is shifted by the interval Dg in the longitudinal direction LGD. As such, the light-emitting element groups 295 are disposed at different positions in the longitudinal direction LGD. In correspondence with this, in the lens arrays 299, the lenses LS are disposed at different positions in the longitudinal direction LGD. In addition, the three light-emitting element groups 295 (and the three lenses LS) are arranged straightly in the direction Da-a. The position of the light-emitting element group 295 can be obtained by using the center of mass of the light-emitting element group 295 as viewed from the front in the light travelling direction Doa. In the same manner, the position of the lens LS can be obtained by using the position of the apex of the lens LS as viewed from the front in the light travelling direction Doa.

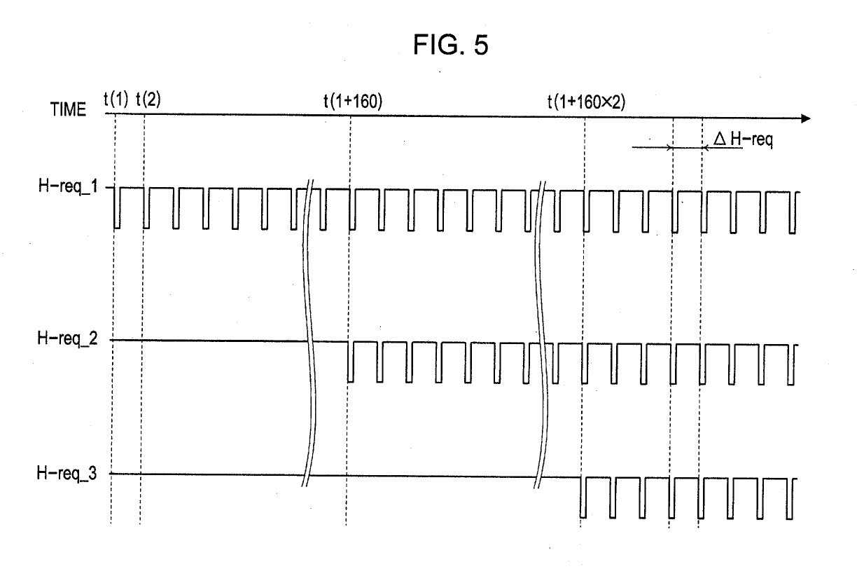

FIG. 5 is a timing chart showing a timing at which a horizontal request signal is output. As described above, the light-emitting operation of the light-emitting element 2951 synchronizes with the horizontal request signal H-req. In addition, in the specification, the sentence that “the light-emitting element 2951 emits light in synchronization with the horizontal request signal H-req”, includes a case where the light-emitting element 2951 emits light simultaneously with the output of the horizontal request signal H-req and a case where the light-emitting element 2951 emits light after a predetermined time from the output of the horizontal request signal H-req.

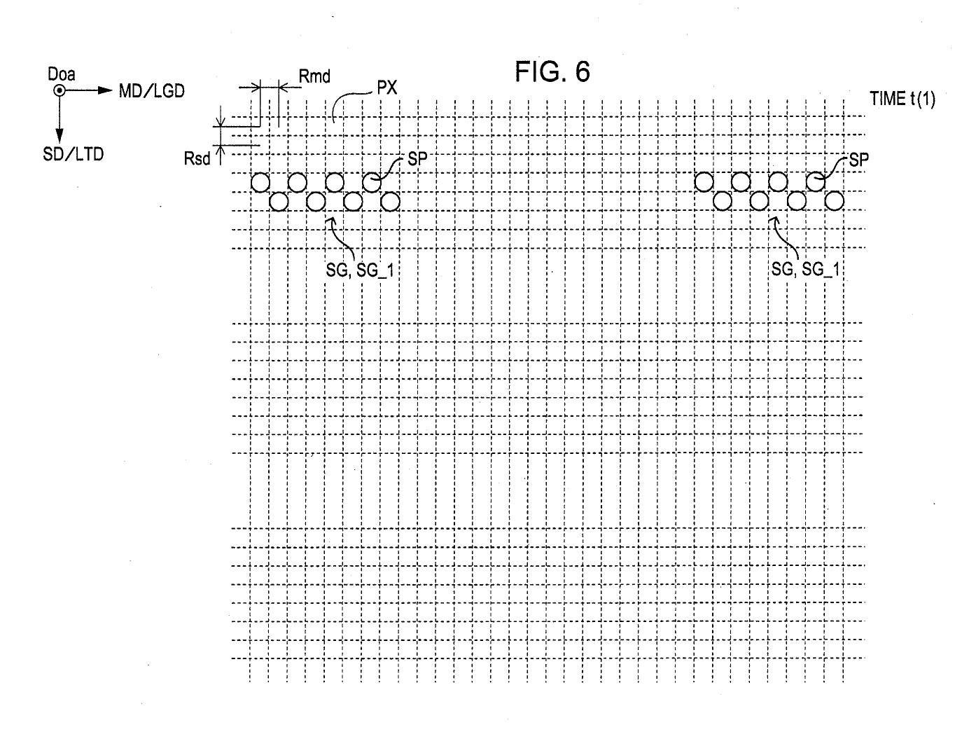

As shown in FIG. 5, in order to form a latent image on the surface of the photoconductive drum 21 by allowing each light-emitting element 2951 to emit at a predetermined interval, the engine controller EC outputs the horizontal request signal H-req at a predetermined interval (at a horizontal request signal interval ΔH-req). Here, in the line head 29, the three lens rows LSR1 to LSR3 are disposed at different positions in the sub-scanning direction SD. Therefore, when a light-emitting operation of the line head 29 is controlled, the engine controller EC outputs three types of horizontal request signals H-req corresponding to the three respective lens rows LSR1 to LSR3. Therefore, the light-emitting element group 295 which emits light that is to be imaged by the lens LS_1 of the lens row LSR1 emits light in synchronization with a horizontal request signal H-req_1, the light-emitting element group 295 which emits light that is to be imaged by the lens LS_2 of the lens row LSR2 emits light in synchronization with a horizontal request signal H-req_2, and the light-emitting element group 295 which emits light that is to be imaged by the lens LS_3 of the lens row LSR3 emits light in synchronization with a horizontal request signal H-req_3. In addition, as illustrated in FIGS. 6 to 9, the surface of the photoconductive drum 21 is exposed.

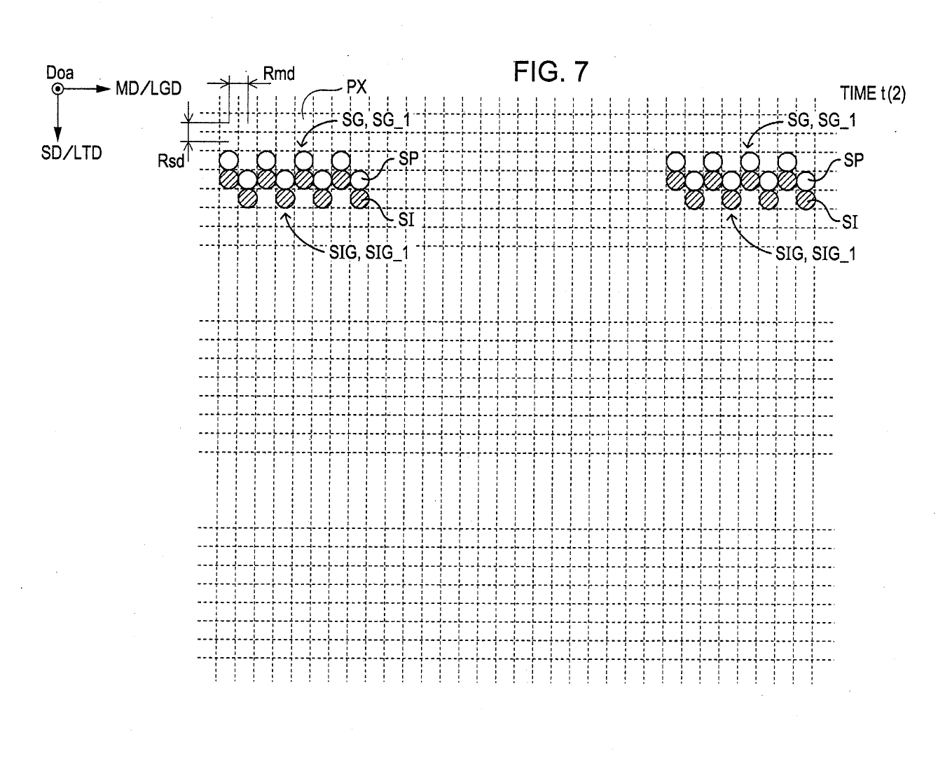

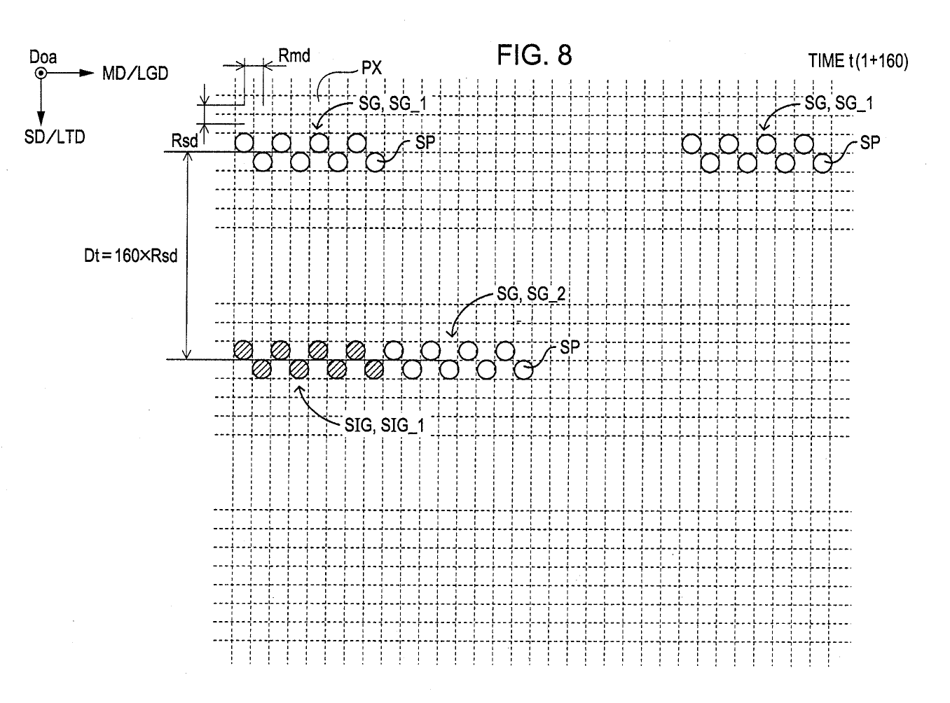

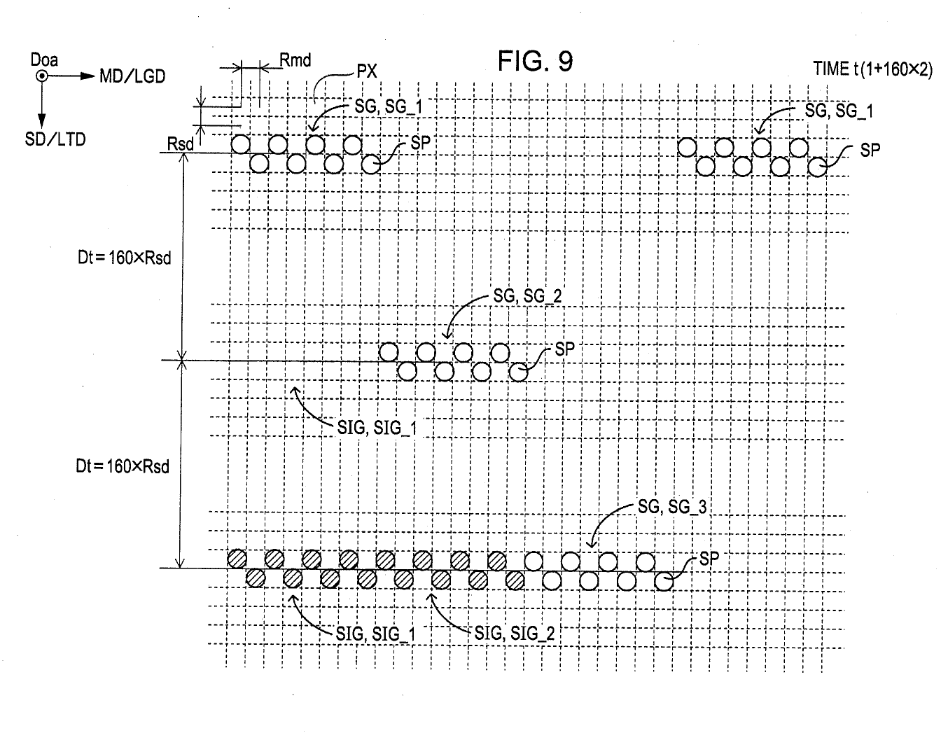

FIG. 6 is a plan view illustrating an exposing operation at time t(1), FIG. 7 is a plan view illustrating an exposing operation at time t(2), FIG. 8 is a plan view illustrating an exposing operation at time t(1+160)=t(161), and FIG. 9 is a plan view illustrating an exposing operation at time t(1+160×2)=t(321). FIGS. 6 to 9 correspond to a case where the photoconductive drum surface is seen through from the rear surface side of the photoconductive drum. In addition, the times t(1), t(2), t(1+160), time t(1+160×2) are times denoted by corresponding reference numerals in FIG. 5. In the figures, a white circle is a spot SP formed by imaging the light emitted from the light-emitting element 2951. In addition, a spot group SG is a group of a plurality of the spots SP formed by one light-emitting element group 295. In addition, a hatched circle is a spot latent image SI formed by exposing the spot SP, and a spot latent image group SIG is a group of the spot latent images SI formed by one light-emitting element group 295.

In the figures, a pixel PX is shown by a dashed square. That is, a plurality of the pixels PX is virtually provided on the surface of the photoconductive drum 21. Specifically, one line of the pixels PX arranged in the main scanning direction MD, and a plurality of the lines are arranged in the sub-scanning direction SD. A pitch between adjacent pixels in the main scanning direction MD is a main scanning pixel pitch Rmd, and a pitch between adjacent pixels in the sub-scanning direction SD is a sub-scanning pixel pitch Rsd. In addition, the interval Dt between the lens rows LSR1, LSR2, and LSR3 in the sub-scanning direction SD is an integral multiple (160) of the sub-scanning pixel pitch Rsd. As described above, in the case where the interval Dt is the integral multiple of the sub-scanning pitch Rsd, it is possible to form the spot SP on each pixel PX by allowing the light-emitting elements 2951 corresponding to the respective lenses LS_1, LS_2, and LS_3 to simultaneously emit light.

The light-emitting element group 295 corresponding to the lens LS_1 emits light in synchronization with the horizontal request signal H-req_1 output at time t(1). Even when a spot group SG_1 is formed as described above (FIG. 6), a spot latent image group is formed at a portion exposed by the spot group SG_1. In addition, the horizontal request signal H-req_1 is output again at time t(2) at which the surface of the photoconductive drum 21 is moved in the sub-scanning direction by one pixel Rsd, and the light-emitting element group 295 corresponding to the lens LS_1 emits light in synchronization with the horizontal request signal H-req_1. As a result, the spot group SG_1 illustrated in FIG. 7 is formed. In addition, a spot latent image group SIG_1 illustrated in FIG. 7 is formed at the time t(1). As described above, by outputting the horizontal request signal H-req at every time period needed for the surface of the photoconductive drum 21 to move by one pixel Rsd in the sub-scanning direction SD, the spot latent image SI can be formed on each pixel PX.

In addition, at time t(1+160) at which the surface of the photoconductive drum 21 moves by one pixel Rsd×160 in the sub-scanning direction from the time t(1), a latent image starts to be formed by the lens LS_2. That is, the horizontal request signal H-req_2 is output at the time t(1+160), and the light-emitting element group 295 corresponding to the lens LS_2 emits light in synchronization with the horizontal request signal H-req_2. Even when the spot group SG_2 is formed as described above (FIG. 8), a spot latent image group is formed at a portion exposed by the spot group SG_2. In addition, the spot latent image group SIG_1 illustrated in FIG. 8 is formed at the time t(1). In this manner, the spot latent image group is formed by the spot group SG_2 adjacent to the spot latent image group SIG_1 formed at the time t(1) in the main scanning direction MD. In addition, the light-emitting element group 295 corresponding to the lens LS_1 emits light at the time t(1+160) to form the spot group SG_1. In FIG. 8, illustration of the spot latent images SI formed at times t(2) to t(160) is omitted.

In addition, at time t(1+160×2) at which the surface of the photoconductive drum 21 moves by one pixel Rsd×160×2 in the sub-scanning direction from the time t(1), a latent image starts to be formed by the lens LS_3. That is, the horizontal request signal H-req_3 is output at the time t(1+160×2), and the light-emitting element group 295 corresponding to the lens LS_3 emits light in synchronization with the horizontal request signal H-req_3. Even when the spot group SG_3 is formed as described above (FIG. 9), a spot latent image group is formed at a portion exposed by the spot group SG_3. In addition, the spot latent image group SIG_1 illustrated in FIG. 9 is formed at the time t(1), and the spot latent image group SIG_2 is formed at the time t(1+160). In this manner, the spot latent image group is formed by the spot group SG_3 adjacent to the spot latent image group SIG_1 formed at the time t(1) and the spot latent image group SIG_2 formed at the time t(1+160) in the main scanning direction MD. In addition, the light-emitting element group 295 corresponding to the lenses LS_1 and LS_2 emits light at the time t(1+160×2) to form the spot groups SG_1 and SG_2. In FIG. 9, illustration of the spot latent images SI formed at times t(2) to t(320) is omitted.

### B. First Embodiment

The image forming apparatus as described above allows each light-emitting element 2951 of the line head 29 at the light-emitting timing according to the movement of the surface of the photoconductive drum 21 in the sub-scanning direction SD to emit light, thereby forming a desired latent image on the surface of the photoconductive drum 21. Here, the photoconductive drum 21 rotates by receiving the rotating force of the drive motor DM attached to the rotation shaft AR21 thereof. However, as described later in detail, there may be a case where the rotation shaft AR21 is eccentric from the center of the photoconductive drum 21 and the speed (circumferential speed) of the surface of the photoconductive drum 21 fluctuates.

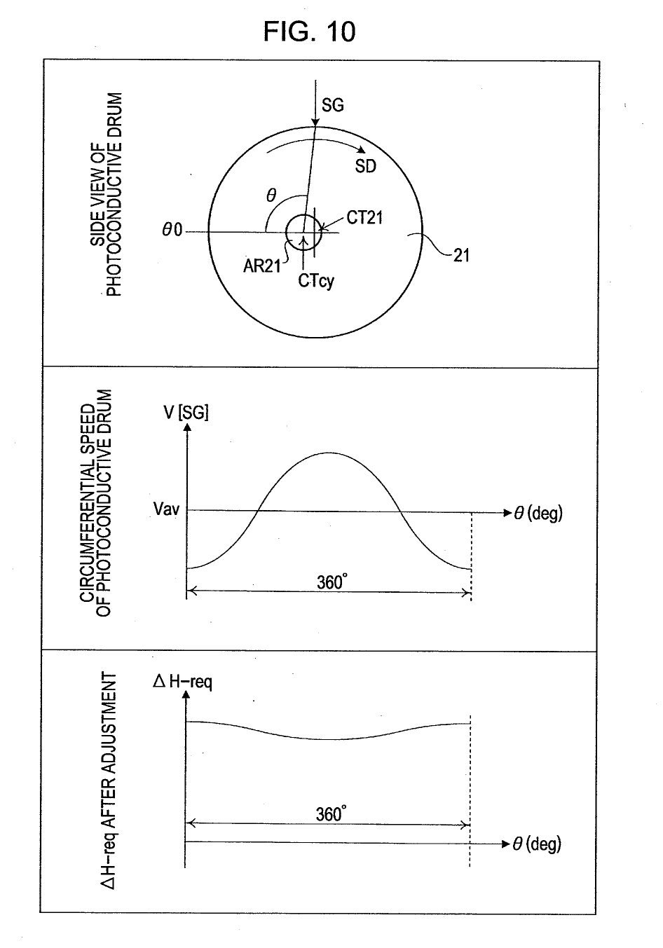

FIG. 10 is a view illustrating effects of the eccentricity of the photoconductive drum on the circumferential speed of the photoconductive drum. A section “side view of photoconductive drum” in FIG. 10 corresponds to a case where the side of the photoconductive drum 21 is viewed from the longitudinal direction LGD. As illustrated in the section, the center CT21 of the photoconductive drum 21 deviates to the right from the center CTcy of the rotation shaft AR21 in the figure, thereby causing the eccentricity of the photoconductive drum 21. When such an eccentricity occurs, a distance from the center CTcy (rotation center) of the rotation shaft AR21 to the surface of the photoconductive drum 21 varies with the position on the surface. As a result, the circumferential speed increases at a position on the surface of the photoconductive drum 21 where a distance from the rotation center CTcy is great, and the circumferential speed decreases at a position where the distance from the rotation center CTcy is small.

Such a state is shown as a graph in a section “circumferential speed of photoconductive drum” in FIG. 10. A horizontal axis of the graph represents a rotation angle θ (deg) of the photoconductive drum 21 and a vertical axis represents the circumferential speed V [SG] of the photoconductive drum 21. The rotation angle θ of the photoconductive drum 21 is an angle from the origin θ0 fixed in the photoconductive drum 21 to a formation position of the spot group SG and varies with the rotation of the photoconductive drum 21 (SIDE VIEW OF PHOTOCONDUCTIVE DRUM). In addition, an arbitrary method may be used to acquire the origin θ0, and a method of acquiring the origin θ0 as illustrated in FIG. 10 is an example. In addition, the formation position of the spot group SG may be obtained as, for example, a geometrical center of the spot group SG. In the graph, the circumferential speed at a position of the spot group SG is illustrated. As shown by the graph, due to the eccentricity of the photoconductive drum 21, the circumferential speed of the photoconductive drum 21 fluctuates from an average circumferential speed Vav at a period of 360° (a period of one rotation of the photoconductive drum 21). In addition, if a fluctuation in the circumferential speed of the photoconductive drum 21 occurs, there may be a case where latent images (the spot latent image groups SIG_1, SIG_2, and SIG_3) to be adjacent to one another in the main scanning direction MD are misaligned in the sub-scanning direction SD.

As such, in order to properly form the latent images, it is important to suppress the effects of the eccentricity of the photoconductive drum 21 on the position of the latent image. Therefore, in this embodiment, in order to control the position of the latent image formed by each lens LS with high precision without being affected by the eccentricity of the photoconductive drum 21, the horizontal request signal interval ΔH-req is adjusted. That is, as shown by a section “ΔH-req after adjustment” in FIG. 10, at a rotation angle θ at which the circumferential speed V [SG] of the photoconductive drum decreases, the horizontal request interval ΔH-req is lengthened, and at a rotation angle θ at which the circumferential speed V [SG] of the photoconductive drum increases, the horizontal request interval ΔH-req is shortened. Specifically, data (data for signal interval adjustment) on the correspondence between the horizontal request signal ΔH-req and the rotation angle θ after adjustment shown in the figure is stored in a memory MM. In addition, the engine controller EC detects the rotation angle θ of the photoconductive drum 21 in the order during the exposing operation, and determines output timings of the horizontal request signals H-req_1, H-req_2, and H-req_3 on the basis of the detected rotation angle θ and the data for signal interval adjustment stored in the memory MM. Next, a configuration for detecting the rotation angle θ of the photoconductive drum 21 will be described.

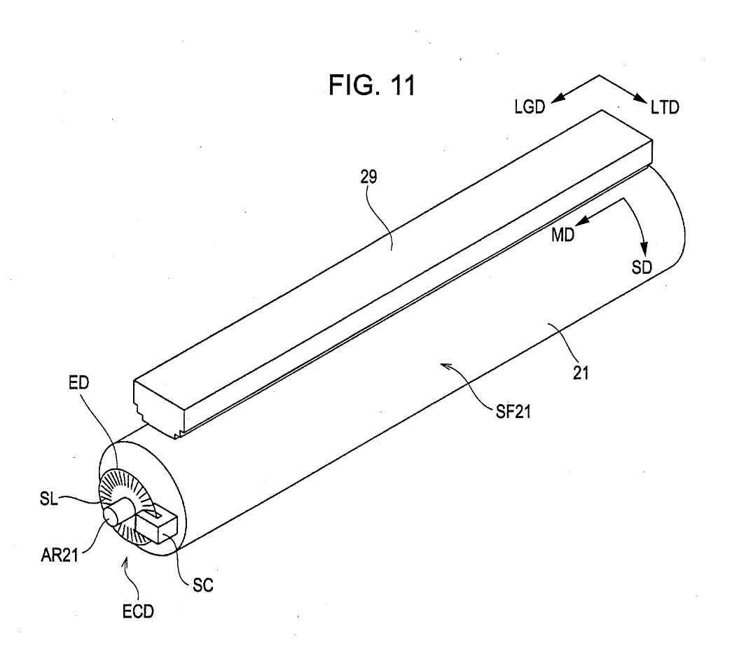

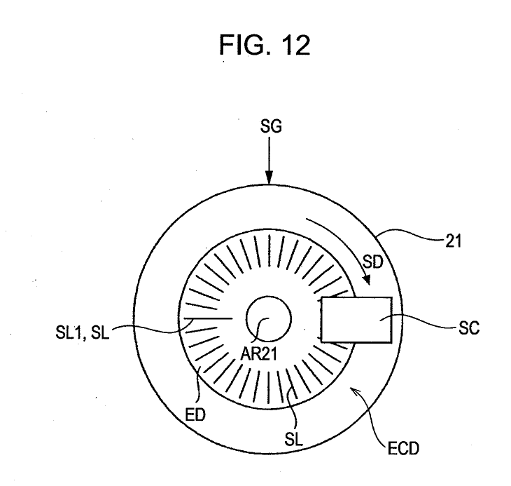

FIG. 11 is a perspective view illustrating the configuration for detecting the rotation angle of the photoconductive drum, and FIG. 12 is a side view illustrating the configuration for detecting the rotation angle of the photoconductive drum. As illustrated in FIGS. 11 and 12, an encoder ECD is mounted to an end portion of the rotation axis AR21 which is perpendicular or substantially perpendicular to the main scanning direction MD. The encoder ECD includes a disk-shaped encoder disk ED and a transmission-type photosensor SC. A center portion of the encoder disk ED is mounted to the rotation shaft AR21 of the photoconductive drum 21, and the encoder disk ED is configured to rotate as the photoconductive drum 21 rotates.

The encoder disk ED is provided with a plurality of (64) slits SL in a radial pattern from the center of the rotation shaft AR21. Then a slit detection signal output by the photosensor SC which detects the slits SL is output to the engine controller EC. In addition, the slit SL1 (reference slit SL1) at a position corresponding to the origin θ0 (FIG. 10) among the 64 slits SL is longer than other slits SL (SL2 to SL64). Therefore, the slit detection signal of the reference slit SL1 is different from the slit detection signals of the slits SL (SL2 to SL64) other than the reference slit SL1. Accordingly, the engine controller EC determines which is the slit detection signal received from the photosensor SC from the slit detection signal of the reference slit SL1 and can detect the rotation angle θ of the photoconductive drum 21. Namely, the engine controller EC can detect the rotation angle θ with respect to the reference slit SL 1. In addition, the engine controller EC can detect an angular speed from a time change in the rotation angle θ.

As described above, in the first embodiment, the output timings of the horizontal request signals H-req_1, H-req_2, and H-req_3 are determined depending on the eccentricity of the photoconductive drum 21. Therefore, for example, a problem in that the spot latent image group SIG_2 is misaligned with the spot latent image group SIG_1 or the spot latent image group SIG_3 is misaligned with the spot latent image group SIG_2 is suppressed. As a result, it is possible to properly form the latent images.

### C. Second Embodiment

In the above-mentioned image forming apparatus, the drive motor DM drives the photoconductive drum 21. However, the driving speed of the drive motor DM may fluctuate, and if a fluctuation in the driving speed occurs, the speed of the surface of the photoconductive drum 21 fluctuates. As a result, there may be a case where a latent image misalignment as described above occurs. In order to cope with such a problem, in the second embodiment, the horizontal request signal H-req is corrected on the basis of the driving speed fluctuation obtained by the output of the encoder ECD. In addition, in the following description, first, a case where a correction of the horizontal request signal H-req based on the driving speed fluctuation is performed without performing the above-mentioned adjustment based on the eccentricity of the photoconductive drum 21 on the horizontal request signal H-req will be described. Thereafter, a method of performing a correction based on both the eccentricity of the photoconductive drum 21 and the driving speed fluctuation on the horizontal request signal H-req will be described.

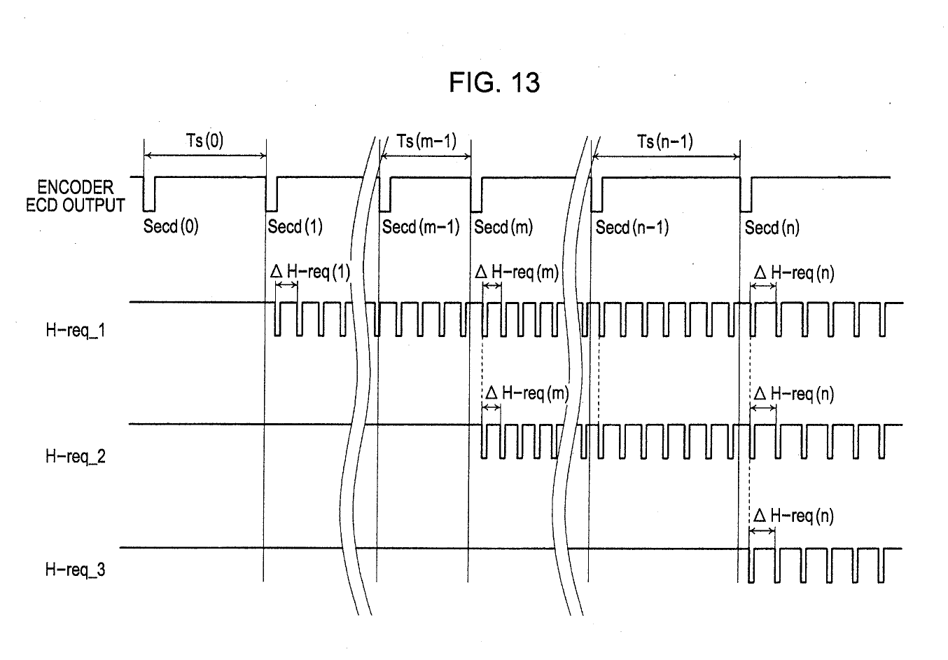

FIG. 13 is a timing chart showing a method of correcting the horizontal request signal on the basis of the driving speed fluctuation. In this embodiment, the horizontal request signal interval ΔH-req is corrected on the basis of a signal Secd of the encoder ECD. In addition, the signal Secd is a slit detection signal output whenever the sensor SC detects the slit SL.

First, a signal interval Ts(0) until a signal Secd(1) is output after the Signal Secd(0) is output is measured. In addition, the horizontal request signal interval ΔH-req(1) after the signal Secd(1) is determined on the basis of the signal interval Ts(0). Specifically, the horizontal request signal interval ΔH-req(1) is determined using an expression:

ΔH-req(1)(Ts(0)/Ts(ref))×ΔH-req(ref) Expression 1.

Here, the reference signal interval Ts(ref) is an output interval of the encoder signal Secd in a case where there is no driving speed fluctuation of the photoconductive drum 21. In addition, the reference horizontal request signal interval ΔH-req(ref) is the horizontal request signal interval ΔH-req in a case where the correction based on the driving speed fluctuation is not performed.

That is, in general, this is as follows: a signal interval Ts(n−1) until a signal Secd(n) is output after a signal Secd(n−1) is output is measured, and then, the horizontal request signal interval ΔH-req(n) after the signal Secd(n) is determined on the basis of the signal interval Ts(n−1) using an expression:

ΔH-req(n)=(Ts(n−1)/Ts(ref))×ΔH-req(ref) Expression 2.

Here, n is an integer equal to or greater than 1. In addition, m in FIG. 13 is also an integer equal to or greater than 1.

As described above, in the second embodiment, the horizontal request signals H-req_1, H-req_2, and H-req_3 are corrected on the basis of the interval Ts at which the signal Seed of the encoder ECD is output. Therefore, the above-mentioned misalignment of the latent images caused by the driving speed fluctuation can be suppressed, so that it is possible to more properly perform the exposing operation. In addition, as described above in the first embodiment, in a case where the adjustment based on the eccentricity of the photoconductive drum 21 is performed on the horizontal request signal H-req, the horizontal request signal interval ΔH-req after the adjustment illustrated in FIG. 10 is substituted for the reference horizontal request signal interval ΔH-req(ref) in Expression 2. Here, the adjusted horizontal request signal interval ΔH-req to be substituted corresponds to the rotation angle θ according to the encoder signals Secd(n−1) to Secd(n). That is, the correction is performed on the basis of the output interval Ts of the encoder signal Secd in addition to the horizontal request signal interval ΔH-req after adjustment which is adjusted depending on the eccentricity of the photoconductive drum 21, thereby suppressing the misalignment of the latent images caused by both the eccentricity of the photoconductive drum 21 and the driving speed fluctuation.

### D. Others

In the above-described embodiments, the photoconductive drum 21 corresponds to a “latent image carrying member” of the invention, the drive motor DM corresponds to a “drive unit” of the invention, the line head 29 corresponds to a “exposure head” of the invention, the memory MM corresponds to a “storage unit” of the invention, the engine controller EC corresponds to a “control unit” of the invention, the data for signal interval adjustment corresponds to a “light-emitting timing adjustment information” of the invention, and the encoder ECD corresponds to a “rotation angle detection unit” of the invention. In addition, a relationship between the time t(1) and the time t(1+160) shown in FIG. 5 and the like corresponds to a relationship between a “first light-emitting timing” and a “second light-emitting timing”, and a relationship between the time t(1+160) and the time t(1+160×2) corresponds to the relationship between the “first light-emitting timing” and the “second light-emitting timing” of the invention.

In addition, the invention is not limited to the embodiments, and various modifications can be made without departing from the spirit and scope of the invention. That is, in the embodiment, the data for signal interval adjustment is stored in the memory MM; however, the data for signal interval adjustment may be stored in another storage element. For example, the data for signal interval adjustment may be stored in a non-volatile memory provided in the cartridge which is able to be attached to or detached from the main body of the image forming apparatus. In this case, the following effects are exhibited. That is, in such a configuration, the cartridge is replaced as necessary for maintenance of the image forming apparatus. In addition, in a case where the photoconductive drum 21 is replaced with a new one due to the replacement of the cartridge, it is necessary to use the data for signal interval adjustment considering the eccentricity of the new photoconductive drum 21. Therefore, if data for signal interval adjustment according to the eccentricity of the photoconductive drum 21 is stored in the non-volatile memory of the cartridge when a factory default of the cartridge is set, with a change in the photoconductive drum 21 due to the replacement of the cartridge, the data for signal interval adjustment can be suitably modified according to the change in the photoconductive drum 21. That is, without performing a specific operation other than the cartridge replacement, suitable data for signal interval adjustment can be prepared. Therefore, this configuration is preferable.

In addition, in this embodiment, the two sheets of the lens arrays 299 are provided, and the lens LS of the lens array 299A and the lens LS of the lens array 299B constitute one imaging optical system. However, the number of sheets of the lens arrays 299 is not limited thereto.

In addition, in the lens array of this embodiment, the three lens rows LSR are provided. However, the number of lens rows LSR is not limited thereto.

In addition, in this embodiment, the light-emitting element group 295 is constituted by the eight light-emitting elements 2951. However, the number of light-emitting elements 2951 constituting the light-emitting element group 295 is not limited thereto.

In this embodiment, the light-emitting element 2951 is a bottom emission-type organic EL element; however, the configuration of the light-emitting element 2951 is not limited thereto. That is, the light-emitting element 2951 may be a top emission-type organic EL element or an LED (Light-Emitting Diode).

The entire disclosure of Japanese Patent Application No: 2009-2436, filed Jan. 8, 2009 is expressly incorporated by reference herein.

What is claimed is:

1. An image forming apparatus comprising:
a latent image carrying member that carries a latent image;
a drive unit that drives the latent image carrying member;
an exposure head that includes a first imaging optical system, a first light-emitting element that emits light imaged on the latent image carrying member by the first imaging optical system, a second imaging optical system that is disposed at a different position from that of the first imaging optical system in a rotation direction of the latent image carrying member, and a second light-emitting element that emits light imaged on the latent image carrying member by the second imaging optical system;
a storage unit that stores light-emitting timing adjustment information used for adjusting a timing at which the second light-emitting element emits light; and
a control unit that determines a first light-emitting timing at which the first light-emitting element emits light and a second light-emitting timing on the basis of the light-emitting timing adjustment information, and allows the second light-emitting element to emit light at the second light-emitting timing.

2. The image forming apparatus according to claim 1, further comprising: a rotation angle detection unit that detects a rotation angle of the latent image carrying member,
wherein the control unit adjusts the second light-emitting timing on the basis of a detection result of the rotation angle detection unit.

3. The image forming apparatus according to claim 2,
wherein the latent image carrying member has a rotation shaft, and
the drive unit drives the rotation shaft.

4. The image forming apparatus according to claim 3, wherein the rotation angle detection unit is an encoder mounted to the rotation shaft of the latent image carrying member.

5. The image forming apparatus according to claim 3, wherein the storage unit is mounted in a cartridge that holds the latent image carrying member and is detachable from a main body of the image forming apparatus.

6. The image forming apparatus according to claim 5, wherein the storage unit is a non-volatile memory.

7. An image forming method comprising:
determining a second light-emitting timing at which a second light-emitting element emits light, the second light-emitting element being included in an exposure head that includes a first imaging optical system, a first light-emitting element that emits light imaged on a latent image carrying member by the first imaging optical system, a second imaging optical system disposed at a different position from that of the first imaging optical system in a rotation direction of the latent image carrying member, and the second light-emitting element that emits light imaged on the latent image carrying member by the second imaging optical system; and
allowing the second light-emitting element to emit light at the second light-emitting timing determined in the determining,
wherein in the determining, light-emitting timing adjustment information used for adjusting the timing at which the second light-emitting element emits light is read from a storage unit, and the second light-emitting timing is determined on the basis of a first light-emitting timing at which the first light-emitting element emits light and the light-emitting timing adjustment information to allow the second light-emitting element to emit light at the second light-emitting timing.
